(19) United States
(12) Patent Application Publication
(10) Pub. No.: US 2026/0267276 A1
(43) Pub. Date: Sep. 10, 2026

(54) IMAGE FORMING APPARATUS

(71) Applicant: FUJIFILM Business Innovation Corp., Tokyo (JP)

(72) Inventors: Satoshi MIZOGUCHI, Kanagawa (JP); Takahiro SUZUKI, Kanagawa (JP); Jiro KORENAGA, Kanagawa (JP)

(73) Assignee: FUJIFILM Business Innovation Corp., Tokyo (JP)

(21) Appl. No.: 19/295,702

(22) Filed: Aug. 11, 2025

(30) Foreign Application Priority Data
Mar. 5, 2025 (JP) 2025-034377

(51) Int. Cl. G03G 15/00; G03G 5/05; G03G 5/06; G03G 15/02; G03G 15/16

(52) U.S. Cl. CPC G03G 15/751; G03G 5/0542; G03G 5/0564; G03G 5/06142; G03G 5/0662; G03G 15/0216; G03G 15/167

(57) ABSTRACT

An image forming apparatus includes a negatively charged photoreceptor, a charging device that charges a surface of the photoreceptor, has a charging member in contact with the photoreceptor, and applies only a direct-current voltage to the charging member, an exposure device that exposes the charged surface of the photoreceptor to form an electrostatic latent image, a developing device that develops the electrostatic latent image formed on the surface of the photoreceptor with a developer containing a toner to form a toner image, a transfer device that transfers the toner image to a surface of a recording medium, and a discharging device that, after the transfer of the toner image to the surface of the recording medium, discharges the surface of the photoreceptor by irradiating the surface of the photoreceptor with light, in which the photoreceptor has a conductive substrate, a charge generation layer disposed on the conductive substrate, a charge transport layer disposed on the charge generation layer, and a protective layer disposed on the charge transport layer, and a value of a ratio L/F of a total thickness L (μm) of the charge transport layer and the protective layer to a dielectric constant ε (F/m) of the entire charge transport layer and protective layer in a thickness direction is 4.0 or more and 6.0 or less, and in a case where the transfer device transfers the toner image to the surface of the recording medium, the photoreceptor is discharged such that the following expression (1) is satisfied at an exposed portion of the photoreceptor and the following expression (2) is satisfied at a non-exposed portion of the photoreceptor,

15%≤a surface potential of the photoreceptor after discharging by the transfer device/a surface potential of the photoreceptor after charging by the charging device≤20%, the expression (1):

25%≤a surface potential of the photoreceptor after discharging by the transfer device/a surface potential of the photoreceptor after charging by the charging device≤50%, the expression (2):
provided that the surface potential of the photoreceptor is a negative potential after the charging by the charging device and is a negative potential even after the discharging by the transfer device.

### CROSS-REFERENCE TO RELATED APPLICATIONS

This application is based on and claims priority under 35 USC 119 from Japanese Patent Application No. 2025-034377 filed Mar. 5, 2025.

### BACKGROUND

### (i) Technical Field

The present disclosure relates to an image forming apparatus.

### (ii) Related Art

JP2022-049167A discloses an electrophotographic apparatus including an electrophotographic photoreceptor and a charging unit that has a charging member disposed in directly contact with the electrophotographic photoreceptor and charges a surface of the electrophotographic photoreceptor by applying only a direct-current voltage to the charging member, in which the electrophotographic apparatus includes a discharging unit, and by the discharging unit, a charging potential of a portion of the electrophotographic photoreceptor that has not been subjected to image exposure is reduced to ⅕ or more and ⅓ or less of a charging potential before the image exposure.

JP2022-180848A discloses an image forming apparatus including an image holding unit that consists of a photoreceptor having a surface protective layer, a charging unit that charges a surface of the image holding unit with a direct-current potential, an exposure unit, a development unit, a transferring unit, an exposure and discharging unit, a transfer and discharging unit that discharges residual electric charges of the image holding unit using a transferring unit, and a switching unit that performs discharging by the exposure and discharging unit under a condition that the residual electric charges of the image holding unit do not exceed a threshold value of an allowable discharging level and performs discharging by the transfer and discharging unit under a condition that the residual electric charges of the image holding unit exceed the threshold value.

### SUMMARY

Aspects of non-limiting embodiments of the present disclosure relate to an image forming apparatus in which fogging, ghost, and a decrease in image density are unlikely to occur.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects.

According to an aspect of the present disclosure, there is provided an image forming apparatus includes a negatively charged photoreceptor, a charging device that charges a surface of the photoreceptor, has a charging member in contact with the photoreceptor, and applies only a direct-current voltage to the charging member, an exposure device that exposes the charged surface of the photoreceptor to form an electrostatic latent image, a developing device that develops the electrostatic latent image formed on the surface of the photoreceptor with a developer containing a toner to form a toner image, a transfer device that transfers the toner image to a surface of a recording medium, and a discharging device that, after the transfer of the toner image to the surface of the recording medium, discharges the surface of the photoreceptor by irradiating the surface of the photoreceptor with light, in which the photoreceptor has a conductive substrate, a charge generation layer disposed on the conductive substrate, a charge transport layer disposed on the charge generation layer, and a protective layer disposed on the charge transport layer, and a value of a ratio L/F of a total thickness L (μm) of the charge transport layer and the protective layer to a dielectric constant ε (F/m) of the entire charge transport layer and protective layer in a thickness direction is 4.0 or more and 6.0 or less, and in a case where the transfer device transfers the toner image to the surface of the recording medium, the photoreceptor is discharged such that the following expression (1) is satisfied at an exposed portion of the photoreceptor and the following expression (2) is satisfied at a non-exposed portion of the photoreceptor,

15%≤a surface potential of the photoreceptor after discharging by the transfer device/a surface potential of the photoreceptor after charging by the charging device≤20%, the expression (1):

25%≤a surface potential of the photoreceptor after discharging by the transfer device/a surface potential of the photoreceptor after charging by the charging device≤50%, the expression (2):
provided that the surface potential of the photoreceptor is a negative potential after the charging by the charging device and is a negative potential even after the discharging by the transfer device.

### BRIEF DESCRIPTION OF THE DRAWINGS

Exemplary embodiment(s) of the present invention will be described in detail based on the following figures, wherein:

FIG. 1 is a view schematically showing a configuration of an example of an image forming apparatus according to the present exemplary embodiment;

FIG. 2 is a view schematically showing a configuration of another example of the image forming apparatus according to the present exemplary embodiment;

FIG. 3 is a partial cross-sectional view showing an example of a layer configuration of the photoreceptor according to the present exemplary embodiment; and

FIG. 4 is a schematic view showing an image formed for evaluating image quality in Examples.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, “A and/or B” is synonymous with “at least one of A or B”. That is, “A and/or B” represents that A alone may be used, B alone may be used, or a combination of A and B may be used.

In the present disclosure, a numerical range described using “to” represents a range including numerical values listed before and after “to” as the minimum value and the maximum value respectively.

Regarding the numerical ranges described in stages in the present disclosure, the upper limit or lower limit of a numerical range may be replaced with the upper limit or lower limit of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, in a case where a compound is represented by a structural formula, the compound may be represented by a structural formula in which symbols representing a carbon atom and a hydrogen atom (C and H) in a hydrocarbon group and/or a hydrocarbon chain are omitted.

In the present disclosure, an alkyl group and an alkylene group are any of linear, branched, or cyclic, unless otherwise specified.

In the present disclosure, a hydrogen atom in an organic group, an aromatic ring, a linking group, an alkyl group, an alkylene group, an aryl group, an aralkyl group, an alkoxy group, an aryloxy group, and the like may be substituted with a halogen atom.

In the present disclosure, “axial direction” of the photoreceptor means a direction in which a rotation axis of the photoreceptor extends, and “circumferential direction” of the photoreceptor means a rotation direction of the photoreceptor.

### Image Forming Apparatus

The image forming apparatus according to the present exemplary embodiment includes a negatively charged photoreceptor, a charging device that charges a surface of the photoreceptor, has a charging member in contact with the photoreceptor, and applies only a direct-current voltage to the charging member, an exposure device that exposes the charged surface of the photoreceptor to form an electrostatic latent image, a developing device that develops the electrostatic latent image formed on the surface of the photoreceptor with a developer containing a toner to form a toner image, a transfer device that transfers the toner image to a surface of a recording medium, and a discharging device that, after the transfer of the toner image to the surface of the recording medium, discharges the surface of the photoreceptor by irradiating the surface of the photoreceptor with light.

The image forming apparatus according to the present exemplary embodiment has the following configuration for the photoreceptor and the transfer device.

The photoreceptor has a conductive substrate, a charge generation layer disposed on the conductive substrate, a charge transport layer disposed on the charge generation layer, and a protective layer disposed on the charge transport layer, and a value of a ratio L/P of a total thickness L (μm) of the charge transport layer and the protective layer to a dielectric constant ε (F/m) of the entire charge transport layer and protective layer in a thickness direction is 4.0 or more and 6.0 or less.

In a case where the transfer device transfers the toner image to the surface of the recording medium, the photoreceptor is discharged such that the following expression (1) is satisfied at an exposed portion of the photoreceptor and the following expression (2) is satisfied at a non-exposed portion of the photoreceptor.

15%≤a surface potential of the photoreceptor after discharging by the transfer device/a surface potential of the photoreceptor after charging by the charging device≤20% Expression (1):

25%≤a surface potential of the photoreceptor after discharging by the transfer device/a surface potential of the photoreceptor after charging by the charging device≤50% Expression (2):

Here, the surface potential of the photoreceptor is a negative potential after the charging by the charging device and is a negative potential even after the discharging by the transfer device.

In the present disclosure, the charging device having the charging member in contact with a photoreceptor, in which only a direct-current voltage is applied to the charging member, is referred to as “contact-type and direct current-type charging device”; and the discharging device that discharges the surface of the photoreceptor by irradiating the surface of the photoreceptor with light is referred to as “exposure-type discharging device”.

In an image forming apparatus including the exposure-type discharging device, charges generated in a charge generation layer of a photoreceptor by discharge light irradiation are gradually accumulated in a charge transport layer and a protective layer, and thus fogging (phenomenon in which toner adheres to a non-image area of a recording medium) may occur.

In addition, an image forming apparatus including the contact-type and direct current-type charging device tends to cause the fogging in a case of continuously forming an image.

With the image forming apparatus according to the present exemplary embodiment, fogging, ghost, and a decrease in image density are unlikely to occur. The mechanism is assumed as follows.

In an image forming apparatus not including the exposure-type discharging device, a residual potential at the time of image formation in the previous round is present, and thus a ghost (phenomenon in which a previous image appears in a subsequent image) may occur. Since the image forming apparatus according to the present exemplary embodiment includes the exposure-type discharging device, the ghost is less likely to occur.

In a case where the value of the ratio L/F of the electrophotographic photoreceptor is less than 4.0, a discharge start voltage decreases and the surface potential increases, so that a post-exposure potential increases and the decrease in image density may occur.

In a case where the value of the ratio L/F of the electrophotographic photoreceptor is more than 6.0, the total thickness L of the charge transport layer and the protective layer is too thick compared to the value of the dielectric constant F, and the charges generated in the charge generation layer by the discharge light irradiation are likely to accumulate in the charge transport layer and the protective layer. As a result, the surface potential of the photoreceptor may decrease, and the fogging may occur.

In order to suppress the above-described event, the value of the ratio L/F is 4.0 or more and 6.0 or less, and for example, is preferably 4.5 or more and 5.8 or less, and more preferably 4.5 or more and 5.5 or less.

In the discharging by the transfer device, in a case where the expression (1) is not satisfied at the exposed portion of the photoreceptor, the potential does not completely decrease, and the residual potential is present during the next image formation, which may cause an increase in surface potential and the decrease in image density.

In the discharging by the transfer device, in a case where the expression (2) is not satisfied in the non-exposed portion of the photoreceptor, the decrease in image density may further occur as described above.

From the above-described viewpoint, in a case where the transfer device transfers the toner image to the surface of the recording medium, for example, it is preferable that the discharging is performed such that a surface potential of the photoreceptor at the exposed portion is −80 V or more and −60 V or less.

In the image forming apparatus according to the present exemplary embodiment, it is presumed that the fogging, the ghost, and the decrease in image density are unlikely to occur due to the above-described synergistic action.

As the image forming apparatus according to the present exemplary embodiment, a known image forming apparatus such as an apparatus including a fixing device that fixes the toner image transferred to the surface of a recording medium; a direct transfer-type apparatus that transfers the toner image formed on the surface of the photoreceptor directly to the recording medium; an intermediate transfer-type apparatus that primarily transfers the toner image formed on the surface of the photoreceptor to a surface of an intermediate transfer member and secondarily transfers the toner image transferred to the surface of the intermediate transfer member to the surface of the recording medium; an apparatus including a cleaning device that cleans the surface of the photoreceptor after the transfer of the toner image and before the charging, and an apparatus including an photoreceptor heating member for increasing the temperature of the photoreceptor and decreasing the relative temperature is adopted.

In a case of the intermediate transfer-type apparatus, the transfer device has a configuration including an intermediate transfer member with surface on which the toner image will be transferred, a primary transfer device that performs primary transfer to transfer the toner image formed on the surface of the photoreceptor to the surface of the intermediate transfer member, and a secondary transfer device that performs secondary transfer to transfer the toner image transferred to the surface of the intermediate transfer member to the surface of a recording medium.

The image forming apparatus according to the present exemplary embodiment may be any of a dry development-type image forming apparatus or a wet development-type (development type using a liquid developer) image forming apparatus.

In the image forming apparatus according to the present exemplary embodiment, for example, a portion including the photoreceptor may have a cartridge structure (process cartridge) that is attachable to and detachable from the image forming apparatus. The process cartridge may include, for example, at least one selected from the group consisting of the charging device, the exposure device, the developing device, the discharging device, and the transfer device, in addition to the photoreceptor.

Hereinafter, an example of the image forming apparatus according to the present exemplary embodiment will be shown in the drawings, but the image forming apparatus according to the present exemplary embodiment is not limited thereto.

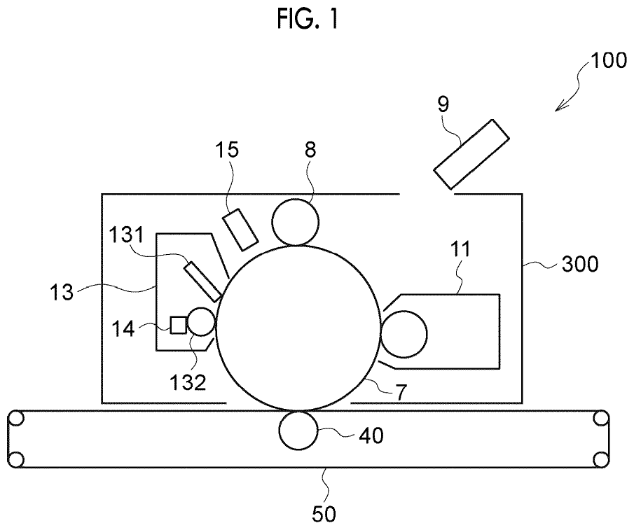

FIG. 1 is a view schematically showing a configuration of an example of the image forming apparatus according to the present exemplary embodiment.

An image forming apparatus 100 shown in FIG. 1 includes a process cartridge 300 including a photoreceptor 7, an exposure device 9, a transfer device 40 (primary transfer device), and an intermediate transfer member 50.

In the image forming apparatus 100, the exposure device 9 is disposed at a position that can be exposed to the photoreceptor 7 from an opening portion of the process cartridge 300; the transfer device 40 is disposed at a position that faces the photoreceptor 7 through the intermediate transfer member 50; and the intermediate transfer member 50 is disposed such that a part of the intermediate transfer member 50 is in contact with the photoreceptor 7. The image forming apparatus 100 also includes a secondary transfer device (not shown) that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 includes, in a housing, a photoreceptor 7, a charging device 8, a developing device 11, a photoreceptor cleaning device 13, and a discharging device 15.

FIG. 1 shows a form in which the discharging device 15 is disposed downstream of the photoreceptor cleaning device, but the discharging device may be disposed upstream of the photoreceptor cleaning device.

The photoreceptor cleaning device 13 has a cleaning blade 131, and the cleaning blade 131 is disposed to come into contact with the surface of the photoreceptor 7. The cleaning member may be a conductive or insulating fibrous member instead of the aspect of the cleaning blade 131, and may be used alone or in combination with the cleaning blade 131.

Although a fibrous roll member 132 that supplies a lubricant 14 to the surface of the photoreceptor 7 is shown in FIG. 1, the fibrous roll member 132 may not be provided.

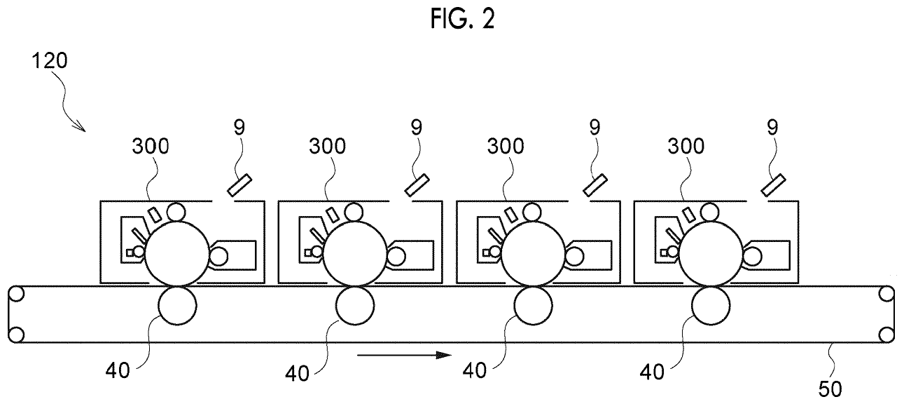

FIG. 2 is a view schematically showing a configuration of another example of the image forming apparatus according to the present exemplary embodiment.

An image forming apparatus 120 shown in FIG. 2 is a tandem type multicolor image forming apparatus in which four process cartridges 300 are mounted. The image forming apparatus 120 is formed such that the four process cartridges 300 are arranged in parallel on the intermediate transfer member 50, and one photoreceptor is used for each color. The image forming apparatus 120 has the same configuration as the image forming apparatus 100, except that the image forming apparatus 120 is of a tandem type.

Hereinafter, each device constituting the image forming apparatus will be described.

### Photoreceptor

The photoreceptor has a conductive substrate, a charge generation layer disposed on the conductive substrate, a charge transport layer disposed on the charge generation layer, and a protective layer disposed on the charge transport layer. The charge generation layer and the charge transport layer are photosensitive layers (so-called lamination-type photosensitive layer or function-separated type photosensitive layer).

The photoreceptor according to the present exemplary embodiment may further has a layer (for example, an undercoat layer or an interlayer) other than the charge generation layer, the charge transport layer, and the protective layer.

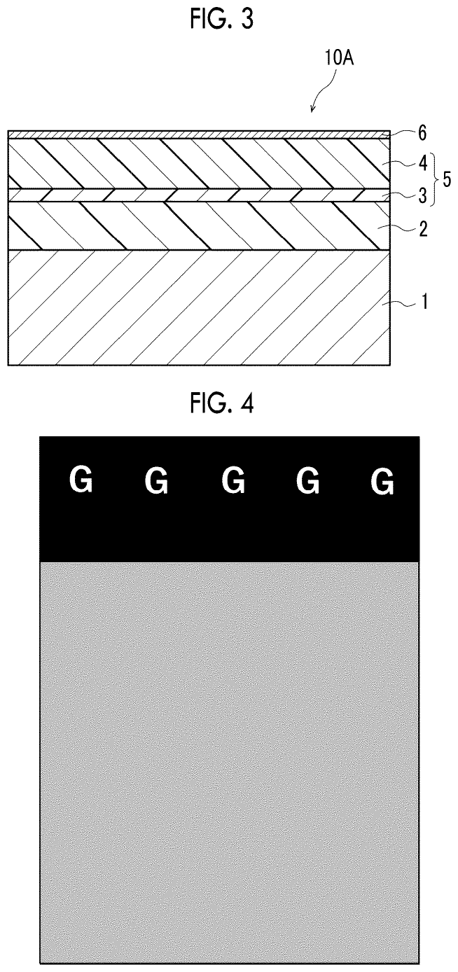

FIG. 3 is a partial cross-sectional view schematically showing an example of a layer configuration of the photoreceptor according to the present exemplary embodiment. A photoreceptor 10A shown in FIG. 3 has a structure in which an undercoat layer 2, a charge generation layer 3, a charge transport layer 4, and a protective layer 6 are laminated in this order on a conductive substrate 1, and the charge generation layer 3 and the charge transport layer 4 constitute a photosensitive layer 5. The photoreceptor 10A may include an interlayer (not shown) between the undercoat layer 2 and the charge generation layer 3. The undercoat layer 2 may or may not be provided.

In the photoreceptor according to the present exemplary embodiment, the value of the ratio L/P of the total thickness L (μm) of the charge transport layer and the protective layer to the dielectric constant ε (F/m) of the entire charge transport layer and protective layer in a thickness direction is 4.0 or more and 6.0 or less, and for example, is preferably 4.5 or more and 5.8 or less, and more preferably 4.5 or more and 5.5 or less.

In the photoreceptor according to the present exemplary embodiment, the total thickness L of the charge transport layer and the protective layer is, for example, preferably 10 m or more and 20 μm or less.

In a case where the total thickness L is 20 μm or less, the charges generated in the charge generation layer by the discharge light irradiation are less likely to accumulate in the charge transport layer and the protective layer. From this viewpoint, the total thickness L is, for example, more preferably 18 μm or less.

In a case where the total thickness L is 10 μm or more, the decrease in image density is less likely to occur. From this viewpoint, the total thickness L is, for example, more preferably 12 μm or more.

In the photoreceptor according to the present exemplary embodiment, for example, it is preferable that a value of a ratio L2/L1 of a layer thickness L2 of the protective layer to a layer thickness L1 of the charge transport layer is 0.1 or more and 1 or less.

In a case where the value of the ratio L2/L1 is 1 or less, the charge transport layer is not too thin, and for example, it is preferable in terms of electrical properties of the photoreceptor. From this viewpoint, the value of the ratio L2/L1 is, for example, more preferably 0.9 or less and still more preferably 0.8 or less.

In a case where the value of the ratio L2/L1 is 0.1 or more, the decrease in image density is less likely to occur. From this viewpoint, the value of the ratio L2/L1 is, for example, more preferably 0.3 or more and still more preferably 0.5 or more.

In the present exemplary embodiment, the layer thickness L1 of the charge transport layer, the layer thickness L2 of the protective layer, and the total thickness L of the charge transport layer and the protective layer are the following physical property values.

The layer thickness L1 of the charge transport layer is a value obtained by measuring a thickness of the charge transport layer at a total of 40 points, that is, 10 points in an axial direction and 4 points in a circumferential direction (at intervals of 90°) of the photoreceptor using an eddy current film thickness meter, and calculating an arithmetic mean thereof.

The layer thickness L2 of the protective layer is a value obtained by measuring a thickness of the protective layer at a total of 40 points, that is, 10 points in an axial direction and 4 points in a circumferential direction (at intervals of 90°) of the photoreceptor using an eddy current film thickness meter, and calculating an arithmetic mean thereof.

The total thickness L of the charge transport layer and the protective layer is a value obtained by summing the layer thickness L1 and the layer thickness L2.

A method of measuring the dielectric constant ε (F/m) of the entire charge transport layer and protective layer in the thickness direction is as follows.

### Production of Sample for Measuring Electrostatic Capacity

A vicinity of the surface of the photoreceptor is cut using a single-edge razor or the like, and the charge transport layer and the protective layer are peeled off with tweezers while being integrated. A gold electrode is formed on both surfaces of the peeled film (laminated film of the charge transport layer and the protective layer) by vacuum vapor deposition or sputtering to obtain a sample for measuring electrostatic capacity.

### Electrostatic Capacity Measurement by Alternating Current Impedance Method

A measurement device and measurement conditions are as follows.
Power supply: SI1287 electrochemical interface (Solartron Analytical)
Ammeter: SI1260 impedance/gain phase analyzer (Solartron Analytical)
Current amplifier: 1296 dielectric interface (Solartron Analytical)
AC voltage: 1 Vp-p
Measurement frequency: from 1 MHz to 1 mHz, applied from a high frequency side
Measurement environment: temperature of 22° C. and relative humidity of 55%

The sample is sandwiched between an aluminum plate (cathode) and a gold electrode (anode), an alternating current impedance is measured under the above-described measurement conditions using the above-described measuring device, and a static capacitance is determined by fitting a Cole-Cole plot to an RC parallel equivalent circuit. The dielectric constant ε is calculated based on an expression: Capacitance C=ε×S/L (S: area of the electrode, L: thickness of the sample).

The value (F/m) of the dielectric constant ε of the entire charge transport layer and protective layer in the thickness direction is, for example, preferably 3.0 or more and 4.0 or less, more preferably 3.1 or more and 3.8 or less, and still more preferably 3.2 or more and 3.5 or less.

A value (F/m) of a dielectric constant ε of the charge transport layer in the thickness direction is, for example, preferably 2.5 or more and 3.8 or less, more preferably 2.8 or more and 3.5 or less, and still more preferably 3.0 or more and 3.3 or less.

A value (F/m) of a dielectric constant ε of the protective layer in the thickness direction is, for example, preferably 3.2 or more and 4.5 or less, more preferably 3.4 or more and 4.2 or less, and still more preferably 3.6 or more and 4.0 or less.

A method of measuring the dielectric constant ε of the charge transport layer in the thickness direction and the dielectric constant ε of the protective layer in the thickness direction is the same as the method of measuring the dielectric constant ε of the entire charge transport layer and protective layer in the thickness direction.

The value (F/m) of the dielectric constant ε of the charge transport layer and the protective layer in the thickness direction can be controlled by a content of a charge transport material contained in each layer. The value of the dielectric constant ε decreases as the content of the charge transport material increases.

Hereinafter, each layer of the photoreceptor according to the present exemplary embodiment will be described in detail.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 1×10¹³ Ω·cm.

In a case where the photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and m or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 1×10² Ω·cm or more and 1×10¹¹ Ω·cm or less.

Among the above, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

A volume-average particle diameter of the inorganic particles may be 50 nm or more and 2,000 nm or less (for example, preferably 60 nm or more and 1,000 nm or less).

A content of the inorganic particles is, for example, preferably 10% by mass or more and 80% by mass or less, and more preferably 40% by mass or more and 80% by mass or less with respect to the binder resin.

The inorganic particles may be subjected to a surface treatment. As the inorganic particles, two or more kinds of inorganic particles subjected to different surface treatments or two or more kinds of inorganic particles having different particle diameters may be used in a form of a mixture.

Examples of a surface treatment agent include a silane coupling agent, a titanate-based coupling agent, an aluminum-based coupling agent, and a surfactant. In particular, for example, a silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane; but the present invention is not limited thereto.

The silane coupling agent may be used in a form of a mixture of two or more kinds thereof. For example, the silane coupling agent having an amino group and other silane coupling agents may be used in combination. Examples of the other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; but the present invention is not limited thereto.

A surface treatment method using the surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, or a derivative thereof is preferable.

The electron-accepting compound may be contained in the undercoat layer in a state of being dispersed with the inorganic particles, or in a state of being attached to the surface of the inorganic particles.

Examples of a method of attaching the electron-accepting compound to the surface of the inorganic particles include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while stirring the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing agitating or using ultrasonic waves, a sand mill, an attritor, or a ball mill, agitating or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while stirring and heating the inorganic particles in a solvent and a method of removing the moisture by azeotropically boiling the inorganic particles with a solvent.

The electron-accepting compound may be attached before or after the inorganic particles are subjected to the surface treatment with the surface treatment agent or simultaneously with the surface treatment with the surface treatment agent.

A content of the electron-accepting compound may be, for example, 0.01% by mass or more and 20% by mass or less, preferably 0.01% by mass or more and 10% by mass or less with respect to the inorganic particles.

Examples of the binder resin used for the undercoat layer include a known polymer compound such as an acetal resin (such as polyvinyl butyral), a polyvinyl alcohol resin, a polyvinyl acetal resin, a casein resin, a polyamide resin, a cellulose resin, gelatin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoat layer also include a charge-transporting resin having a charge-transporting group, and a conductive resin (for example, polyaniline or the like).

Among the above, as the binder resin used for the undercoat layer, for example, a resin insoluble in a coating solvent of an upper layer is suitable; and a resin obtained by a reaction between at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin, and a curing agent is particularly suitable.

In a case where these binder resins are used in combination of two or more kinds thereof, a mixing proportion thereof is set as necessary.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the undercoat layer as the additive.

Examples of the silane coupling agent as the additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, ethylacetoacetate aluminum diisopropylate, and aluminum tris(ethylacetoacetate).

These additives may be used alone or in a form of a mixture or a polycondensate of a plurality of compounds.

The undercoat layer may have, for example, a Vickers hardness of 35 or more.

For example, the surface roughness (ten-point average roughness) of the undercoat layer may be adjusted to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

A thickness of the undercoat layer is set to, for example, preferably 15 μm or more, and more preferably in a range of 20 μm or more and 50 μm or less.

### Interlayer

An interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A thickness of the interlayer is set to, for example, preferably in a range of 0.1 μm or more and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is suitable in a case where an incoherent light source such as a light emitting diode (LED) and an organic electroluminescence (EL) image array is used.

Examples of the charge generation material include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer. The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 1×10¹³ Ω·cm or more.

The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A thickness of the charge generation layer is set to, for example, preferably in a range of 0.1 μm or more and 5.0 μm or less and more preferably in a range of 0.2 μm or more and 2.0 μm or less.

### Charge Transport Layer

A charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

From the viewpoint of charge mobility, for example, a triarylamine derivative represented by Structural Formula (a-1) or a benzidine derivative represented by Structural Formula (a-2) is preferable as the charge transport material.

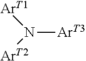

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}) or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

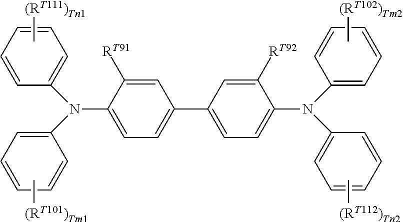

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}) or —CH═CH—CH═C(R^{T15})(R^{T16}), in which R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

Among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})”, or a benzidine derivative having “—CH═CH—CH═C(R^{T15})(R^{T16})” is preferable from the viewpoint of the charge mobility.

Examples of the polymer charge transport material include known materials having charge transport properties, such as poly-N-vinylcarbazole and polysilane. Among these, for example, a polyester-based polymer charge transport material is preferable. The polymer charge transport material may be used alone or in combination of the binder resin.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. The binder resins may be used alone or in combination of two or more kinds thereof. A blending ratio between the charge transport material and the binder resin is, for example, preferably 10:1 to 1:5 in terms of mass ratio.

From the viewpoint of durability of the charge transport layer, for example, at least one selected from the group consisting of a polycarbonate resin and a polyarylate resin is suitable as the binder resin. As the polycarbonate resin and the polyarylate resin, only the polycarbonate resin or only the polyarylate resin may be used, or the polycarbonate resin and the polyarylate resin may be mixed and used.

The charge transport layer may also contain other known additives. Examples of the additive include an antioxidant, a leveling agent, an antifoaming agent, a filler, and a viscosity adjuster.

The formation of the charge transport layer is not particularly limited, and a known forming method is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

A thickness of the charge transport layer is, for example, preferably 5 μm or more and m or less, more preferably 8 μm or more and 20 μm or less, and still more preferably 10 μm or more and 15 μm or less.

In a case where the thickness of the charge transport layer is 30 μm or less, the charges generated in the charge generation layer by the discharge light irradiation are less likely to accumulate in the charge transport layer, and as a result, the fogging is less likely to occur in the image. From this viewpoint, the thickness of the charge transport layer is, for example, more preferably 20 μm or less and still more preferably 15 μm or less.

In a case where the thickness of the charge transport layer is 5 μm or more, for example, it is preferable in terms of the electrical properties of the photoreceptor. From this viewpoint, the thickness of the charge transport layer is, for example, more preferably 8 μm or more and still more preferably 10 μm or more.

### Protective Layer

The protective layer is provided on the photosensitive layer. The protective layer is the outermost surface layer of the photoreceptor. The protective layer is provided, for example, for the purpose of suppressing a chemical change of the photosensitive layer during charging and for the purpose of improving a mechanical strength of the photosensitive layer.

The protective layer is, for example, preferably a layer of a cured film or a crosslinked film, and specifically, preferably in the following form (1) or form (2). According to the following form (1) or form (2), the chemical change of the photosensitive layer during charging is suppressed, and abrasion resistance of the protective layer is more excellent.

Form (1): a cured film or a crosslinked film of a composition containing a reactive charge transport material having a reactive group and a charge transport skeleton in the same molecule; that is, a layer containing a polymerized substance or a crosslinked substance of the reactive charge transport material. The layer may contain a polymerized substance or a crosslinked substance of a reactive non-charge transport material having a reactive group in the molecule and not having a charge transport skeleton. The layer may contain a polymerized substance or a crosslinked substance of the reactive charge transport material and the reactive non-charge transport material. The layer may contain a non-reactive charge transport material having no reactive group in the molecule.

Form (2): a cured film or a crosslinked film of a composition containing a non-reactive charge transport material having no reactive group in the molecule, and a reactive non-charge transport material having a reactive group in the molecule and not having a charge transport skeleton; that is, a layer containing a polymerized substance or a crosslinked substance of the non-reactive charge transport material and the reactive non-charge transport material.

The protective layer is, for example, preferably in the form (1) among the form (1) and the form (2). The form (1) has a higher hardness of the protective layer and excellent abrasion resistance as compared with the form (2).

The reactive charge transport material, the non-reactive charge transport material, and the reactive non-charge transport material may be selected from known materials. Hereinafter, each of the reactive charge transport material, the non-reactive charge transport material, and the reactive non-charge transport material will be described.

Examples of the reactive group of the reactive charge transport material include known reactive groups such as a chain polymerizable group, an epoxy group, —OH, —OR [R represents an alkyl group], —NH₂, —SH, —COOH, and —SiR^{a}₃₋ₙ(OR^{b})ₙ [R^{a} represents a hydrogen atom, an alkyl group, or a substituted or unsubstituted aryl group, R^{b} represents a hydrogen atom, an alkyl group, or a trialkylsilyl group, and n represents an integer of 1 or more and 3 or less]. Examples of the reactive group of the reactive non-charge transport material also include the above-described reactive groups.

The chain polymerizable group may be a functional group capable of radical polymerization, and is, for example, a functional group having a carbon double bond. Specific examples thereof include groups having at least one selected from a vinyl group, a vinyl ether group, a vinyl thioether group, a styryl group (phenylvinyl group), a vinylphenyl group, an acryloyl group, a methacryloyl group, or a derivative thereof. From the viewpoint that reactivity is excellent, the chain polymerizable group is, for example, preferably a group having at least one selected from a vinyl group, a styryl group (phenylvinyl group), a vinylphenyl group, an acryloyl group, a methacryloyl group, or a derivative thereof.

Examples of the charge transport skeleton of the reactive charge transport material include a skeleton derived from a nitrogen-containing hole transport compound such as a triarylamine-based compound (compound having a triarylamine skeleton), a benzidine-based compound (compound having a benzidine skeleton), and a hydrazone-based compound (compound having a hydrazone skeleton), in which the skeleton has a structure that is conjugated with a nitrogen atom. As the charge transport skeleton of the reactive charge transport material, for example, a triarylamine skeleton is preferable.

The reactive charge transport materials may be used alone or in combination of two or more kinds thereof.

From the viewpoint of excellent charge transportability, the reactive charge transport material is, for example, preferably a compound represented by Formula (A).

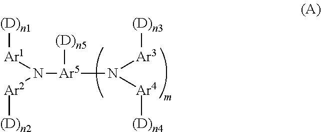

In Formula (A), Ar¹, Ar², Ar³, and Ar⁴ each independently represent a substituted or unsubstituted aryl group, Ar⁵ represents a substituted or unsubstituted aryl group or a substituted or unsubstituted arylene group, D represents an organic group having a chain polymerizable group, an epoxy group, —OH, —OR [R represents an alkyl group], —NH₂, —SH, —COOH, or —SiR^{a}₃₋ₙ(OR^{b})ₙ [R^{a} represents a hydrogen atom, an alkyl group, or a substituted or unsubstituted aryl group, R^{b} represents a hydrogen atom, an alkyl group, or a trialkylsilyl group, and n represents an integer of 1 or more and 3 or less], n1, n2, n3, n4, and n5 each independently represent an integer of 0 or more and 2 or less, m represents 0 or 1, and the total number of D's is 1 or more and 8 or less.

From the viewpoint of obtaining a protective layer having higher strength, the total number of D's is, for example, preferably 2 or more, and more preferably 4 or more. From the viewpoint of reducing a proportion of unreacted reactive groups, the total number of D's is, for example, preferably 7 or less and more preferably 6 or less.

In Formula (A), Ar¹, Ar², Ar³, and Ar⁴ each independently represent a substituted or unsubstituted aryl group. Ar¹, Ar², Ar³, and Ar⁴ may be the same or different from each other. Examples of the substituent in the substituted aryl group, as a substituent other than D, include an alkyl group having 1 or more and 4 or less carbon atoms, an alkoxy group having 1 or more and 4 or less carbon atoms, and a substituted or unsubstituted aryl group having 6 or more and 10 or less carbon atoms.

For example, it is preferable that —Ar¹-(D)ₙ₁, —Ar²-(D)ₙ₂, —Ar³-(D)ₙ₃, and —Ar⁴-(D)ₙ₄ in Formula (A) are each independently any of Formulae (1) to (7).

In Formulae (1) to (7), -(D)ₙ is used for collectively representing -(D)ₙ₁, -(D)ₙ₂, -(D)ₙ₃, and -(D)ₙ₄ linked to Ar¹, Ar², Ar³, and Ar⁴, respectively.

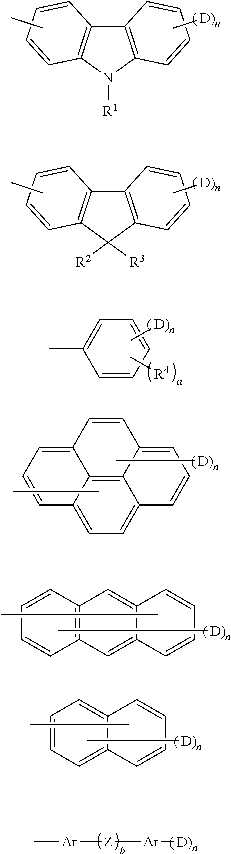

In Formulae (1) to (7), D has the same meaning as “D” in Formula (A), and n represents 1 or 2.

In Formula (1), R¹ represents a hydrogen atom, an alkyl group having 1 or more and 4 or less carbon atoms, an alkoxy group having 1 or more and 4 or less carbon atoms, an unsubstituted phenyl group, or a phenyl group substituted with an alkyl group having 1 or more and 4 or less carbon atoms or an alkoxy group having 1 or more and 4 or less carbon atoms.

In Formula (2), R² and R³ each independently represent a hydrogen atom, an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom.

In Formula (3), R⁴ represents an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, and a represents an integer of 0 or more and 4 or less.

In Formula (7), two Ar's each independently represent a substituted or unsubstituted arylene group, Z represents a divalent organic linking group, and b represents 0 or 1.

As Ar in Formula (7), for example, an arylene group represented by Formula (8) or an arylene group represented by Formula (9) is preferable.

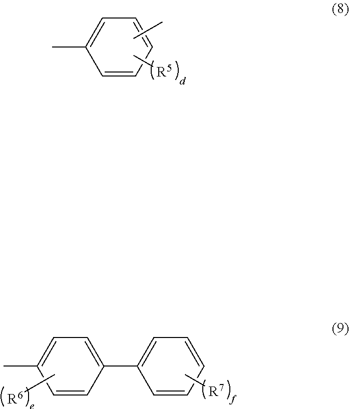

In Formula (8), R⁵ represents an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, and d represents an integer of 0 or more and 4 or less.

In Formula (9), R⁶ and R⁷ each independently represent an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, and e and f each independently represent an integer of 0 or more and 4 or less.

As Z in Formula (7), for example, any one of a divalent linking group represented by Formula (10), a divalent linking group represented by Formula (11), a divalent linking group represented by Formula (12), a divalent linking group represented by Formula (13), a divalent linking group represented by Formula (14), a divalent linking group represented by Formula (15), a divalent linking group represented by Formula (16), or a divalent linking group represented by Formula (17); or a combination thereof is preferable.

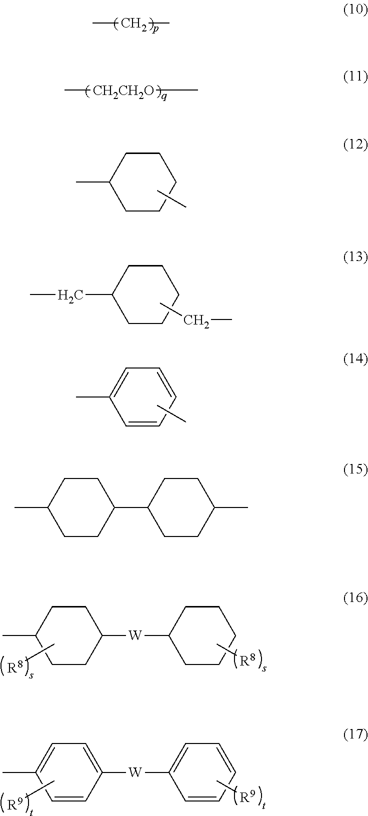

In Formula (10), p represents an integer of 1 or more and 10 or less.

In Formula (11), q represents an integer of 1 or more and 10 or less.

In Formula (16), R⁸ represents an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, s represents an integer of 0 or more and 4 or less, and W represents a divalent linking group.

In Formula (17), R⁹ represents an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, t represents an integer of 0 or more and 4 or less, and W represents a divalent linking group.

As W in Formula (16) and Formula (17), for example, any one of a divalent linking group represented by Formula (18), a divalent linking group represented by Formula (19), a divalent linking group represented by Formula (20), a divalent linking group represented by Formula (21), a divalent linking group represented by Formula (22), a divalent linking group represented by Formula (23), a divalent linking group represented by Formula (24), a divalent linking group represented by Formula (25), or a divalent linking group represented by Formula (26) is preferable.

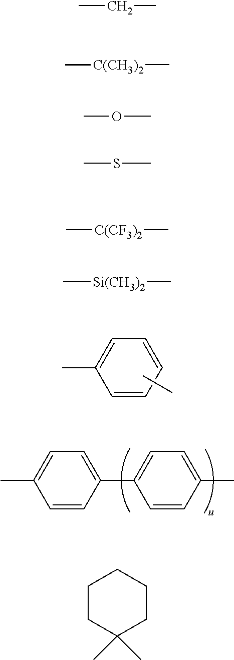

In Formula (25), u represents an integer of 0 or more and 3 or less.

In a case where m in Formula (A) is 0, Ar⁵ is a substituted or unsubstituted aryl group. Examples of the aryl group of Ar⁵ include the aryl group described above as the form of Ar¹ and the like.

In a case where m in Formula (A) is 1, Ar⁵ is a substituted or unsubstituted arylene group. Examples of the arylene group of Ar⁵ include an arylene group obtained by removing a hydrogen atom at a position where —N(Ar³-(D)ₙ₃)(Ar⁴-(D)ₙ₄) is substituted, from the aryl group described above as the form of Ar¹ and the like.

Examples of the reactive charge transport material include the following CTM (R1) to CTM (R4) and CTM (CP1) to CTM (CP4).

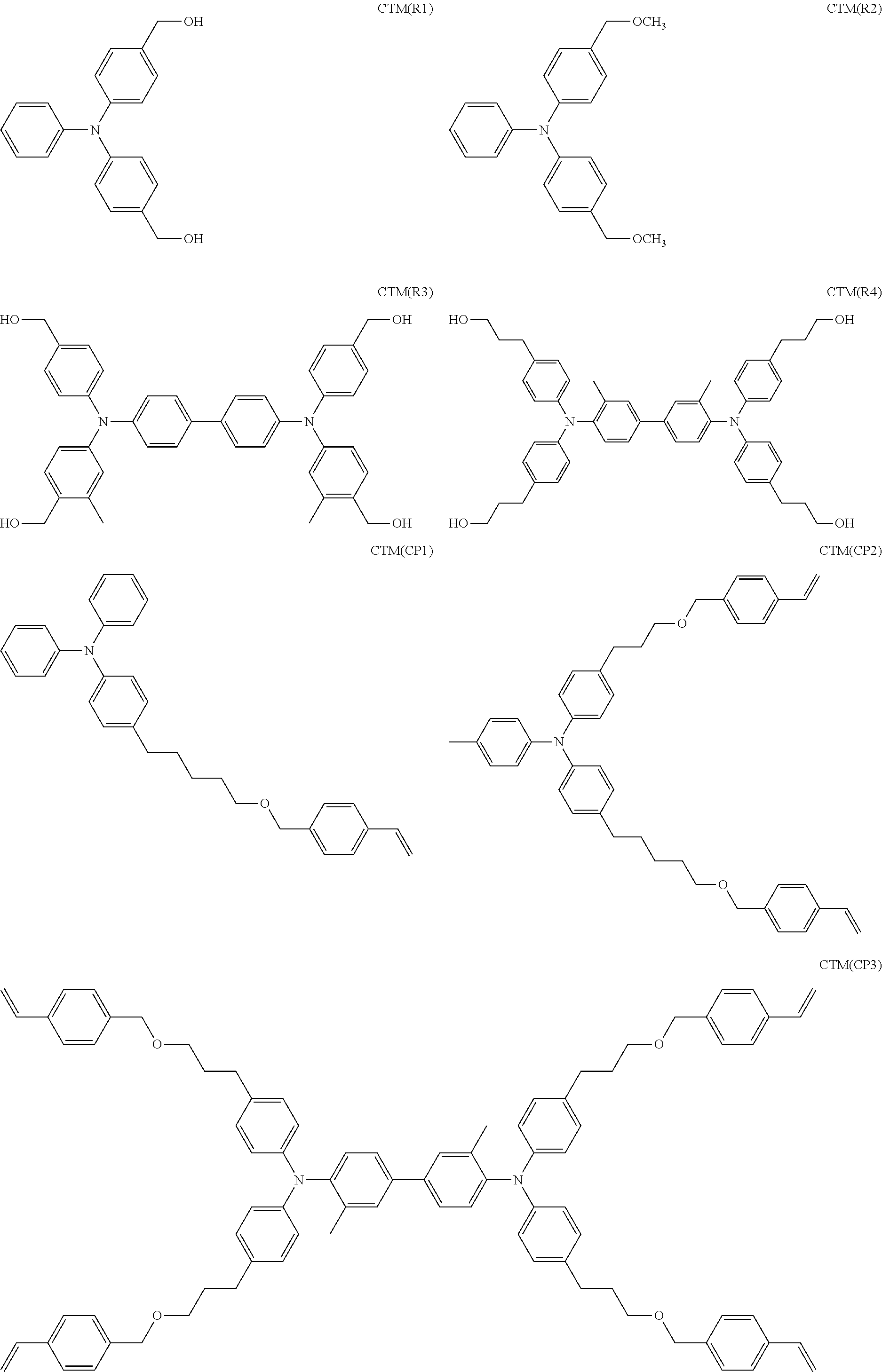

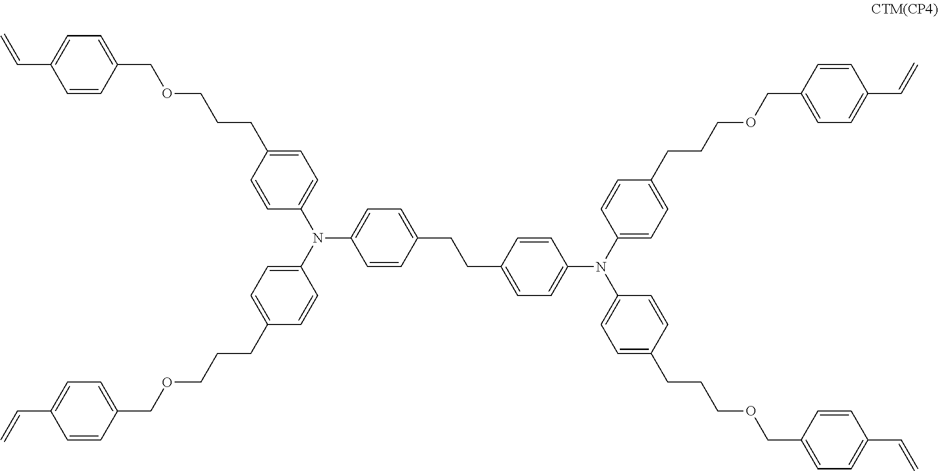 [SMILES: C=Cc1ccc(COCCCc2ccc(N(c3ccc(CCCOCc4ccc(C=C)cc4)cc3)c3ccc(CCc4ccc(N(c5ccc(CCCOCc6ccc(C=C)cc6)cc5)c5ccc(CCCOCc6ccc(C=C)cc6)cc5)cc4)cc3)cc2)cc1]

A content of the reactive charge transport material is, for example, preferably 30% by mass or more and 100% by mass or less, more preferably 40% by mass or more and 100% by mass or less, and still more preferably 50% by mass or more and 100% by mass or less with respect to the solid content of a composition for forming the protective layer (for example, a coating solution for forming the protective layer). In a case where the content of the reactive charge transport material is within the above-described range, the protective layer can be made relatively thick, and thus the decrease in image density is less likely to occur on the surface of the photoreceptor.

In a case where a chain polymerizable charge transport material is used as the reactive charge transport material, a content of the chain polymerizable charge transport material is, for example, preferably 30% by mass or more and 100% by mass or less, more preferably 40% by mass or more and 100% by mass or less, and still more preferably 50% by mass or more and 100% by mass or less with respect to the solid content of a composition for forming the protective layer (for example, a coating solution for forming the protective layer). In a case where the content of the chain polymerizable charge transport material is within the above-described range, the protective layer can be made relatively thick, and thus the decrease in image density is less likely to occur on the surface of the photoreceptor.

Examples of the non-reactive charge transport material include electron-transporting compounds, for example, a quinone-based compound such as p-benzoquinone, chloranil, bromanil, or anthraquinone; a tetracyanoquinodimethane-based compound; a fluorenone compound such as 2,4,7-trinitrofluorenone; a xanthone-based compound; a benzophenone-based compound; a cyanovinyl-based compound; and an ethylene-based compound. Examples of the non-reactive charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The non-reactive charge transport materials may be used alone or in combination of two or more kinds thereof.

Examples of the non-reactive charge transport material include the following CTM (NR1).

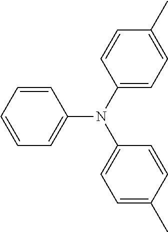 [SMILES: Cc1ccc(N(c2ccccc2)c2ccc(C)cc2)cc1]

Examples of the reactive non-charge transport material include a thermosetting resin and a curing agent. The reactive non-charge transport materials may be used alone or in combination of two or more kinds thereof.

Examples of the thermosetting resin include a guanamine resin, a melamine resin, a phenol resin, a urea resin, and an alkyd resin.

Examples of the curing agent include a compound having a guanamine structure (hereinafter, also referred to as “guanamine compound”) and a compound having a melamine structure (hereinafter, also referred to as “melamine compound”).

Examples of the exemplary embodiment of the protective layer include a cured film or a crosslinked film containing a polymerized substance or a crosslinked substance of the reactive charge transport material and at least one selected from the group consisting of a guanamine resin, a melamine resin, a guanamine compound, and a melamine compound. From the viewpoint of more excellent abrasion resistance, the protective layer as the cured film or the crosslinked film is, for example, a preferred form.

The protective layer may contain fluororesin particles. In the protective layer containing fluororesin particles, unevenness is formed on the outer peripheral surface of the protective layer, and thus the abrasion resistance is more excellent.

Examples of a fluororesin constituting the fluororesin particles include polytetrafluoroethylene (PTFE; also referred to as a tetrafluoroethylene resin), a perfluoroalkoxy fluororesin, polychlorotrifluoroethylene, polyvinylidene fluoride, polydichlorodifluoroethylene, a tetrafluoroethylene-perfluoroalkyl vinyl ether copolymer, a tetrafluoroethylene-hexafluoropropylene copolymer, a tetrafluoroethylene-ethylene copolymer, a tetrafluoroethylene-hexafluoropropylene-perfluoroalkyl vinyl ether copolymer, and a tetrafluoroethylene-perfluoroalkoxy ethylene copolymer. From the viewpoint of abrasion resistance and cleaning performance of the protective layer, the fluororesin constituting the fluororesin particles is, for example, preferably polytetrafluoroethylene or a copolymer of tetrafluoroethylene and perfluoroalkoxyethylene. The fluororesin particles may be used alone or in combination of two or more kinds thereof.

A weight-average molecular weight of the fluororesin constituting the fluororesin particles is, for example, preferably 3,000 or more and 5,000,000 or less.

An average primary particle size of the fluororesin particles is, for example, preferably 0.05 μm or more and 10 μm or less, and more preferably 0.1 μm or more and 5 μm or less.

The average primary particle size of the fluororesin particles refers to a value measured at a refractive index of 1.35 using a laser diffraction/scattering-type particle diameter distribution analyzer for a dispersion liquid in which the fluororesin particles are dispersed.

A mass proportion of the fluororesin particles in the protective layer is, for example, preferably 5% by mass or more and 15% by mass or less, and more preferably 7% by mass or more and 12% by mass or less.

The protective layer is formed, for example, by preparing a coating solution for forming the protective layer, that contains the above-described components and a solvent or a dispersion medium, applying the coating solution for forming the protective layer onto the photosensitive layer to form a coating film, and drying the coating film. As necessary, the coating film is subjected to a curing treatment such as heating.

Examples of the solvent or dispersion medium for preparing the coating solution for forming the protective layer include an aromatic solvent such as toluene and xylene; a ketone-based solvent such as methyl ethyl ketone, methyl isobutyl ketone, and cyclohexanone; an ester-based solvent such as ethyl acetate and butyl acetate; an ether-based solvent such as tetrahydrofuran and dioxane; a cellosolve-based solvent such as ethylene glycol monomethyl ether; and an alcohol-based solvent such as isopropyl alcohol and butanol. These solvents may be used alone or in combination of two or more kinds thereof.

Examples of the method of coating the photosensitive layer with the coating solution for forming the protective layer include typical methods such as a dip coating method, a push-up coating method, a wire bar coating method, a spray coating method, a blade coating method, an air knife coating method, and a curtain coating method.

A thickness of the protective layer is, for example, preferably 2 μm or more and 10 μm or less, more preferably 3 μm or more and 9 μm or less, and still more preferably 4 μm or more and 8 μm or less.

In a case where the thickness of the protective layer is 10 μm or less, the charges generated in the charge generation layer by the discharge light irradiation are less likely to accumulate in the protective layer, and as a result, the fogging is less likely to occur in the image. From this viewpoint, the thickness of the protective layer is, for example, more preferably 9 μm or less and still more preferably 8 μm or less.

In a case where the thickness of the protective layer is 2 μm or more, the decrease in image density is less likely to occur on the surface of the photoreceptor. From this viewpoint, the thickness of the protective layer is, for example, more preferably 3 μm or more and still more preferably 4 μm or more.

### Charging Device

The charging device is the contact-type and direct current-type charging device. As the charging device, for example, a contact-type charger formed of a conductive or semi-conductive charging roller, a charging brush, a charging film, a charging rubber blade, a charging tube, or the like is used.

### Exposure Device

Examples of the exposure device include an optical system device that exposes the surface of the photoreceptor to light such as a semiconductor laser beam, LED light, and liquid crystal shutter light in a predetermined image pattern. A wavelength of the light source is set to be within a spectral sensitivity region of the photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. In addition, a surface emission-type laser light source capable of outputting a multi-beam is also effective for forming a color image.

### Developing Device

Examples of the developing device include a typical developing device that performs development in contact or non-contact with the developer. The developing device is not particularly limited as long as the device has the above-described functions, and is selected depending on the purpose thereof. Examples thereof include known developing machines having a function of attaching a one-component developer or a two-component developer to the photoreceptor using a brush, a roller, or the like. Among the above, for example, a developing roller in which a developer is retained on a surface is preferably used.

The developer used in the developing device may be a one-component developer containing only a toner or a two-component developer containing a toner and a carrier. In addition, the developer may be magnetic or non-magnetic. These developers are adopted as the developer.

### Photoreceptor Cleaning Device

The photoreceptor cleaning device includes a cleaning blade-type device including a cleaning blade. In addition to the cleaning blade-type device, a fur brush cleaning-type device or a simultaneous development cleaning-type device may be adopted.

### Discharging Device

The discharging device is the exposure-type discharging device that irradiates the surface of the photoreceptor with discharge light to remove the residual potential on the photoreceptor. The discharging device is a light irradiation device that irradiates the entire region of the photoreceptor in the rotation axis direction; and examples thereof include a halogen lamp, a tungsten lamp, and an LED lamp. A wavelength of the discharge light is, for example, 600 nm or more and 700 nm or less, and an intensity of the discharge light is, for example, 5 mJ/m² or more and 100 mJ/m² or less.

### Transfer Device

Examples of the transfer device include a known transfer charger such as a contact type transfer charger using a belt, a roller, a film, a rubber blade, or the like, and a scorotron transfer charger or a corotron transfer charger using corona discharge.

In a case where the transfer device transfers the toner image to the surface of the recording medium, for example, it is preferable that the discharging is performed such that a surface potential of the photoreceptor at the exposed portion is −80 V or more and −60 V or less. From the viewpoint of achieving the discharging, the transfer current applied to the transfer device is, for example, preferably 9 μA or more and 20 μA or less, more preferably 10 μA or more and 17 μA or less, and still more preferably 10 μA or more and 15 μA or less.

### Intermediate Transfer Member

As the intermediate transfer member, a semi-conductive belt-like intermediate transfer member (intermediate transfer belt) containing polyimide, polyamide-imide, polycarbonate, polyarylate, polyester, rubber, or the like is used. In addition, as the form of the intermediate transfer member, a drum-like intermediate transfer member may be used in addition to the belt-like intermediate transfer member.

### EXAMPLES

Hereinafter, exemplary embodiments of the present invention will be specifically described based on Examples. However, the exemplary embodiments of the present invention are not limited to Examples.

In the following description, unless otherwise specified, “parts” and “%” are based on mass.

In the following description, the synthesis, the production, the treatment, the measurement, and the like are carried out at room temperature (25° C.±3° C.), unless otherwise specified.

### Example 1

### Production of Photoreceptor

### Formation of Undercoat Layer

An aluminum cylindrical tube having an outer diameter of 30 mm, a length of 365 mm, and a thickness of 1 mm is prepared as a conductive substrate.

100 parts of zinc oxide (average particle size: 70 nm, specific surface area: 15 m²/g, manufactured by Tayca Corporation) is stirred and mixed with 500 parts of toluene, 1.3 parts of a silane coupling agent (N-2-(aminoethyl)-3-aminopropyltrimethoxysilane, trade name: KBM603, manufactured by Shin-Etsu Chemical Co., Ltd.) is added thereto, and the mixture is stirred for 2 hours. Next, the toluene is distilled off under reduced pressure and baked at 120° C. for 3 hours to obtain zinc oxide subjected to a surface treatment with the silane coupling agent.

110 parts of the surface-treated zinc oxide is stirred and mixed with 500 parts of tetrahydrofuran, a solution obtained by dissolving 0.6 parts of alizarin in 50 parts of tetrahydrofuran is added thereto, and the mixture is stirred at 50° C. for 5 hours. Next, the solid content is separated by filtration by carrying out filtration under reduced pressure, and dried at 60° C. under reduced pressure, thereby obtaining zinc oxide with alizarin.

100 parts of a solution obtained by dissolving 60 parts of the zinc oxide with alizarin, 13.5 parts of a curing agent (blocked isocyanate, trade name: SUMIDUR 3175, Sumitomo Bayer Urethane Co., Ltd.), and 15 parts of a butyral resin (trade name: S-LEC BM-1, Sekisui Chemical Co., Ltd.) in 68 parts of methyl ethyl ketone is mixed with 5 parts of methyl ethyl ketone, and the mixture is dispersed in a sand mill for 2 hours using glass beads with a diameter of 1 mm, thereby obtaining a dispersion. 0.005 parts of dioctyl tin dilaurate as a catalyst and 4 parts of silicone resin particles (trade name: TOSPEARL 145, Momentive Performance Materials Inc.) are added to the dispersion liquid to obtain a coating solution for forming an undercoat layer. The outer peripheral surface of the conductive substrate is coated with the coating solution for forming an undercoat layer by a dip coating method, and dried and cured at 170° C. for 40 minutes to form an undercoat layer with an average thickness of 25 m.

### Formation of Charge Generation Layer

A mixture of 15 parts of hydroxygallium phthalocyanine as a charge generation material (having diffraction peaks at positions where Bragg angles (2θ±0.2°) in the X-ray diffraction spectrum using CuKα characteristic X-rays are at least of 7.5°, 9.9°, 12.5, 16.3°, 18.6°, 25.1°, and 28.3°), 10 parts of a vinyl chloride-vinyl acetate copolymer resin (trade name: VMCH, Nippon Unicar Company Limited) as a binder resin, and 200 parts of n-butyl acetate is dispersed in a sand mill for 4 hours using glass beads with a diameter of 1 mm. 175 parts of n-butyl acetate and 180 parts of methyl ethyl ketone are added to the dispersion, and the mixture is stirred to obtain a coating solution for forming a charge generation layer. The undercoat layer is dipped in and coated with the coating solution for forming a charge generation layer, and dried at room temperature (25° C.±3° C.) to form a charge generation layer having an average thickness of 0.18 μm.

### Formation of Charge Transport Layer

Binder resin: polycarbonate resin (PC1) (viscosity-average molecular weight: 50,000)

| | | |
|---|---|---|
| Binder resin: polycarbonate resin (PC1) (viscosity- | 50 | parts |
| average molecular weight: 50,000) | | |
| Charge transport material: CTM (1) | 50 | parts |
| Solvent: tetrahydrofuran | 200 | parts |
| Solvent: toluene | 50 | parts |

The above-described materials are mixed to obtain a coating solution for forming a charge transport layer. The charge generation layer is dipped and coated with the coating solution for forming a charge transport layer, and dried at 145° C. for 30 minutes to form a charge transport layer having a layer thickness of 13.0 m.

Chemical structures of the polycarbonate resin (PC1) and CTM (1) are shown below. A numerical value in the structural formula of the polycarbonate resin (PC1) is a molar ratio.

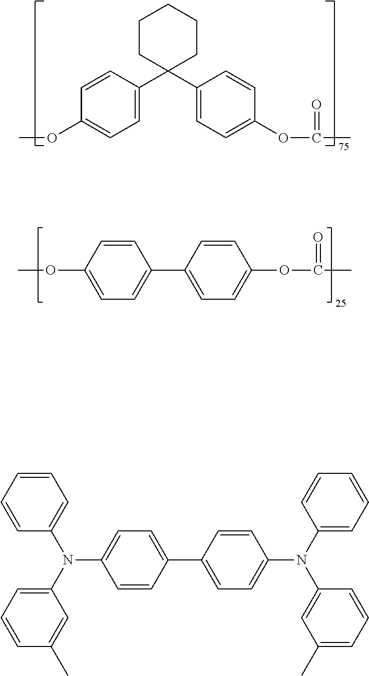

### Formation of Protective Layer

| Reactive charge transport material: CTM (R1) | 70 | parts |
|---|---|---|
| Reactive charge transport material: CTM (R2) | 15 | parts |
| Reactive non-charge transport material | 4.4 | parts |
| (thermosetting resin): benzoguanamine resin | | |
| (trade name: NIKALAC BL-60, Sanwa Chemical Co., Ltd.) | | |
| Curing catalyst: NACURE 5225 (King Industries, Inc.) | 0.1 | parts |
| Solvent: 2-propanol | 220 | parts |

The above-described materials are mixed to obtain a coating solution for forming a protective layer. The charge transport layer is dipped in the coating solution for forming a protective layer, and dried at room temperature (25° C.±3° C.) for 30 minutes. Next, the coating film is put into a heating furnace and subjected to a heat treatment for 20 minutes at an oxygen concentration of 110 ppm and a temperature of 155° C. under a nitrogen stream to cure the protective layer, thereby forming a protective layer having a layer thickness of 7.5 μm.

Chemical structures of CTM (R1) and CTM (R2) are shown below.

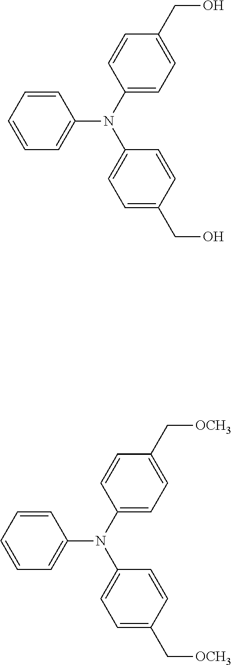 [SMILES: OCc1ccc(N(c2ccccc2)c2ccc(CO)cc2)cc1 ; COCc1ccc(N(c2ccccc2)c2ccc(COC)cc2)cc1]

### Production of Image Forming Apparatus

A photoreceptor is installed in an image forming apparatus DocuCentre-V C2263 (FUJIFILM Business Innovation Corporation) including a contact-type and direct current-type charging device in which a charging member is a charging roll, an intermediate transfer-type transfer device, and an exposure-type discharging device.

The transfer current applied to the primary transfer device of the transfer device is set as shown in Table 2.

In the exposure-type discharging device, a discharge light source is an LED lamp, a wavelength of the discharge light is 600 nm or more and 700 nm or less, and an intensity of discharge light is 50 mJ/m².

### Examples 2 to 5 and Comparative Examples 1 to 5

A photoreceptor is produced in the same manner as in Example 1, except that the layer thickness of the charge transport layer and the layer thickness of the protective layer are changed as shown in Table 1. In addition, the transfer current applied to the primary transfer device is set as shown in Table 2. In Comparative Example 3, the exposure-type discharging device is removed.

### Performance Evaluation

### Amount of Variation in Surface Potential

The following operation is carried out in an environment of a temperature of 28° C. and a relative humidity of 85%.

A potential probe of a surface potential meter (Trek Japan Co., Ltd., Model 347) is installed at a position of a developing machine of the image forming apparatus. Five sheets of A4-sized plain paper are passed through the photoreceptor, and a surface potential (V) of the photoreceptor on the fifth sheet is measured (referred to as “surface potential (1)”). The potential probe is removed, and 1,000 white sheets of A4-sized plain paper are passed through. The potential probe is re-installed at the position of the developing machine, five sheets of A4-sized plain paper are passed through the photoreceptor, and a surface potential (V) of the photoreceptor on the fifth sheet is measured (referred to as “surface potential (2)”). A difference between the surface potential (1) and the surface potential (2) is calculated. The results are shown in Table 2. An amount of variation in the surface potential before and after passing through 1,000 white sheets of A4-sized plain paper is within an allowable range of less than 25 V.

### Amount of Variation in Potential After Exposure

The following operation is carried out in an environment of a temperature of 28° C. and a relative humidity of 85%.

A potential probe of a surface potential meter (Trek Japan Co., Ltd., Model 347) is installed at a position of a developing machine of the image forming apparatus. Five sheets of A4-sized plain paper are exposed to a halftone (image density) of 100% and then passed through the photoreceptor, and a surface potential (V) of the photoreceptor on the fifth sheet is measured (referred to as “surface potential (3)”). The potential probe is removed, and 1,000 white sheets of A4-sized plain paper are passed through. The potential probe is re-installed at the position of the developing machine, five sheets of A4-sized plain paper are exposed to a halftone (image density) of 100% and then passed through the photoreceptor, and a surface potential (V) of the photoreceptor on the fifth sheet is measured (referred to as “surface potential (4)”). A difference between the surface potential (3) and the surface potential (4) is calculated. The results are shown in Table 2. An amount of variation in the surface potential after the exposure, before and after passing through 1,000 white sheets of A4-sized plain paper, is within an allowable range of less than 20 V.

### Surface Potential After Discharging by Transfer

The following operation is carried out in an environment of a temperature of 22° C. and a relative humidity of 55%.

A potential probe of a surface potential meter (Trek Japan Co., Ltd., Model 347) is installed at a position of a cleaning blade of the image forming apparatus. One sheet of A4-sized plain paper with an exposure image having a halftone (image density) of 100% is passed through the photoreceptor, and one sheet of A4-sized plain paper with a non-exposure image having a blank portion is passed through the photoreceptor, and surface potentials (V) of the exposed portion and the non-exposed portion of the photoreceptor are measured (referred to as “surface potential (5) of exposed portion” and “surface potential (5) of non-exposed portion”). The results are shown in Table 2.

### Fogging

In an environment of a temperature of 22° C. and a relative humidity of 55%, 1,000 sheets of A4-sized plain paper are output to form a completely black image using the image forming apparatus. Subsequently, five sheets of A4-sized plain paper having 0% halftone (imageless) are passed through the photoreceptor, and the five sheets are visually observed and classified as follows. The results are shown in Table 2.
A: fogging does not occur.
B: fogging occur, but is within an allowable range.
C: obvious fogging occur, and an outside of the allowable range.

### Ghost and Decrease in Image Density

In an environment of a temperature of 22° C. and a relative humidity of 55%, 5,000 sheets of A4-sized plain paper with an image (image having a region with five white characters “G” in a black image having an image density of 100% and a region of a black halftone image having an image density of 40%) shown in FIG. 4 are continuously output. The last five sheets are visually observed and classified as follows. The results are shown in Table 2.

### Ghost

A: characters “G” are not visible in the halftone region of 40%.
B: characters “G” are visible in the halftone region of 40%, but this is acceptable in terms of practical use.
C: characters “G” are visible in the halftone region of 40%, and this is not acceptable in terms of practical use.

### Decrease in Image Density

A: there is no decrease in density of the black halftone image.
B: decrease in density is noticeable in the black halftone image, but this is acceptable in terms of practical use.
C: there is the decrease in density of the black halftone image, and this is not acceptable in terms of practical use.

TABLE 1

| | Photoreceptor | | | | | | | |
|---|---|---|---|---|---|---|---|---|
| | | | | | | Entire charge transport layer | | |
| | | | | | | and protective layer | | |
| | Charge transport layer | | Protective layer | | Ratio of layer | Total | | |
| | Layer | Dielectric | Layer | Dielectric | thicknesses | thickness L | Dielectric | |
| | thickness L1 | constant ε | thickness L2 | constant ε | L2/L1 | (L1 + L2) | constant ε | L/ε |
| | μm | F/m | μm | F/m | — | μm | F/m | — |
| Comparative | 14.0 | 3.2 | 7.0 | 3.8 | 0.50 | 21.0 | 3.4 | 6.2 |
| Example 1 | | | | | | | | |
| Example 1 | 13.0 | 3.2 | 7.5 | 3.8 | 0.58 | 20.5 | 3.4 | 6.0 |
| Example 2 | 13.0 | 3.2 | 7.0 | 3.8 | 0.54 | 20.0 | 3.4 | 5.9 |
| Example 3 | 11.0 | 3.2 | 7.0 | 3.8 | 0.64 | 18.0 | 3.4 | 5.3 |
| Comparative | 11.0 | 3.2 | 7.0 | 3.8 | 0.64 | 18.0 | 3.4 | 5.3 |
| Example 2 | | | | | | | | |
| Comparative | 11.0 | 3.2 | 7.0 | 3.8 | 0.64 | 18.0 | 3.4 | 5.3 |
| Example 3 | | | | | | | | |
| Example 4 | 8.0 | 3.2 | 9.0 | 3.8 | 1.13 | 17.0 | 3.4 | 5.0 |
| Example 5 | 11.0 | 3.2 | 4.0 | 3.8 | 0.36 | 15.0 | 3.3 | 4.5 |
| Comparative | 11.0 | 3.2 | 2.0 | 3.8 | 0.18 | 13.0 | 3.3 | 3.9 |
| Example 4 | | | | | | | | |
| Comparative | 11.0 | 3.2 | 4.0 | 3.8 | 0.36 | 15.0 | 3.3 | 4.5 |
| Example 5 | | | | | | | | |

TABLE 2

| | | | | | | | | Photoreceptor | | | | |
|---|---|---|---|---|---|---|---|---|---|---|---|---|
| | Photo- | | Photoreceptor | | | | | | Amount | | | |
| | receptor | | Surface potential after | | | | | Amount | of | | | |
| | Surface | | discharging by transfer | | | | | of | variation | Image | | |
| | potential | Transfer | | | Non- | | | variation | in | | | Decrease |
| | after | device | Exposed | | exposed | | Discharging | in | potential | | | in image |
| | charging | Transfer | portion | | portion | | device | surface | after | Fogging | Ghost | density |
| | (a) | current | (b) | (b)/(a) | (c) | (c)/(a) | Presence or | potential | exposure | Classifi- | Classifi- | Classifi- |
| | V | μA | V | % | V | % | absence | V | V | cation | cation | cation |
| Comparative | −400 | 12 | −60 | 15.0 | −100 | 25.0 | Presence | 25 | 5 | C | A | A |
| Example 1 | | | | | | | | | | | | |
| Example 1 | −400 | 12 | −62 | 15.5 | −105 | 26.3 | Presence | 21 | 5 | B | A | A |
| Example 2 | −400 | 12 | −65 | 16.3 | −110 | 27.5 | Presence | 18 | 6 | A | A | A |
| Example 3 | −400 | 12 | −70 | 17.5 | −135 | 33.8 | Presence | 16 | 9 | A | A | A |
| Comparative | −400 | 8 | −100 | 25.0 | −230 | 57.5 | Presence | 11 | 21 | A | A | C |
| Example 2 | | | | | | | | | | | | |
| Comparative | −400 | 12 | −70 | 17.5 | −135 | 33.8 | Absence | 16 | 9 | A | C | A |
| Example 3 | | | | | | | | | | | | |
| Example 4 | −400 | 12 | −75 | 18.8 | −160 | 40.0 | Presence | 21 | 12 | B | A | A |
| Example 5 | −400 | 12 | −80 | 20.0 | −185 | 46.3 | Presence | 13 | 16 | A | A | B |
| Comparative | −400 | 12 | −90 | 22.5 | −220 | 55.0 | Presence | 12 | 20 | A | A | C |
| Example 4 | | | | | | | | | | | | |
| Comparative | −400 | 21 | 20 | — | −50 | 12.5 | Presence | 32 | 12 | C | A | A |
| Example 5 | | | | | | | | | | | | |

The image forming apparatus according to the present disclosure includes the following aspects.

### Supplementary Note

(((1)))

An image forming apparatus comprising:
a negatively charged photoreceptor;
a charging device that charges a surface of the photoreceptor, has a charging member in contact with the photoreceptor, and applies only a direct-current voltage to the charging member;
an exposure device that exposes the charged surface of the photoreceptor to form an electrostatic latent image;
a developing device that develops the electrostatic latent image formed on the surface of the photoreceptor with a developer containing a toner to form a toner image;
a transfer device that transfers the toner image to a surface of a recording medium; and
a discharging device that, after the transfer of the toner image to the surface of the recording medium, discharges the surface of the photoreceptor by irradiating the surface of the photoreceptor with light,
wherein the photoreceptor has a conductive substrate, a charge generation layer disposed on the conductive substrate, a charge transport layer disposed on the charge generation layer, and a protective layer disposed on the charge transport layer, and a value of a ratio L/F of a total thickness L (μm) of the charge transport layer and the protective layer to a dielectric constant ε (F/m) of the entire charge transport layer and protective layer in a thickness direction is 4.0 or more and 6.0 or less, and
in a case where the transfer device transfers the toner image to the surface of the recording medium, the photoreceptor is discharged such that the following expression (1) is satisfied at an exposed portion of the photoreceptor and the following expression (2) is satisfied at a non-exposed portion of the photoreceptor,

15%≤a surface potential of the photoreceptor after discharging by the transfer device/a surface potential of the photoreceptor after charging by the charging device≤20%, the expression (1):

25%≤a surface potential of the photoreceptor after discharging by the transfer device/a surface potential of the photoreceptor after charging by the charging device≤50%, the expression (2):
provided that the surface potential of the photoreceptor is a negative potential after the charging by the charging device and is a negative potential even after the discharging by the transfer device.
   (((2)))

The image forming apparatus according to (((1))),
wherein, in the case where the transfer device transfers the toner image to the surface of the recording medium, the discharging is performed such that a surface potential of the photoreceptor at the exposed portion is −80 V or more and −60 V or less.
   (((3)))

The image forming apparatus according to (((1))) or (((2))),
wherein the value of the ratio L/F is 4.5 or more and 5.5 or less.
   (((4)))

The image forming apparatus according to any one of (((1))) to (((3))),
wherein the protective layer is a cured film or a crosslinked film of a composition containing a reactive charge transport material.
   (((5)))

The image forming apparatus according to any one of (((1))) to (((4))),
wherein the total thickness L is 10 μm or more and 20 μm or less.
   (((6)))

The image forming apparatus according to any one of (((1))) to (((5))),
wherein a value of a ratio L2/L1 of a layer thickness L2 of the protective layer to a layer thickness L1 of the charge transport layer is 0.1 or more and 1 or less.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a negatively charged photoreceptor;
a charging device that charges a surface of the photoreceptor, has a charging member in contact with the photoreceptor, and applies only a direct-current voltage to the charging member;
an exposure device that exposes the charged surface of the photoreceptor to form an electrostatic latent image;
a developing device that develops the electrostatic latent image formed on the surface of the photoreceptor with a developer containing a toner to form a toner image;
a transfer device that transfers the toner image to a surface of a recording medium; and
a discharging device that, after the transfer of the toner image to the surface of the recording medium, discharges the surface of the photoreceptor by irradiating the surface of the photoreceptor with light,
wherein the photoreceptor has a conductive substrate, a charge generation layer disposed on the conductive substrate, a charge transport layer disposed on the charge generation layer, and a protective layer disposed on the charge transport layer, and a value of a ratio L/F of a total thickness L (μm) of the charge transport layer and the protective layer to a dielectric constant ε (F/m) of the entire charge transport layer and protective layer in a thickness direction is 4.0 or more and 6.0 or less, and
in a case where the transfer device transfers the toner image to the surface of the recording medium, the photoreceptor is discharged such that the following expression (1) is satisfied at an exposed portion of the photoreceptor and the following expression (2) is satisfied at a non-exposed portion of the photoreceptor,
15%≤a surface potential of the photoreceptor after discharging by the transfer device/a surface potential of the photoreceptor after charging by the charging device≤20%, the expression (1):
25%≤a surface potential of the photoreceptor after discharging by the transfer device/a surface potential of the photoreceptor after charging by the charging device≤50%, the expression (2):
provided that the surface potential of the photoreceptor is a negative potential after the charging by the charging device and is a negative potential even after the discharging by the transfer device.

2. The image forming apparatus according to claim 1,
wherein, in the case where the transfer device transfers the toner image to the surface of the recording medium, the discharging is performed such that a surface potential of the photoreceptor at the exposed portion is −80 V or more and −60 V or less.

3. The image forming apparatus according to claim 1,
wherein the value of the ratio L/F is 4.5 or more and 5.5 or less.

4. The image forming apparatus according to claim 1,
wherein the protective layer is a cured film or a crosslinked film of a composition containing a reactive charge transport material.

5. The image forming apparatus according to claim 1,
wherein the total thickness L is 10 μm or more and 20 μm or less.

6. The image forming apparatus according to claim 1,
wherein a value of a ratio L2/L1 of a layer thickness L2 of the protective layer to a layer thickness L1 of the charge transport layer is 0.1 or more and 1 or less.
